(19) United States
(12) Patent Application Publication
(10) Pub. No.: US 2026/0188019 A1
(43) Pub. Date: Jul. 2, 2026

(54) SYSTEM AND METHOD FOR ENHANCING VISION-LANGUAGE MODELS WITH SCENE GRAPHS FOR TRAFFIC ACCIDENT UNDERSTANDING

(71) Applicant: Robert Bosch GmbH, Stuttgart (DE)

(72) Inventors: Jonathan Francis, Pittsburgh, PA (US); Alessandro Oltramari, Pittsburgh, PA (US)

(21) Appl. No.: 19/004,996

(22) Filed: Dec. 30, 2024

(51) Int. Cl. G06V 20/54; G06V 10/426; G06V 10/764

(52) U.S. Cl. CPC G06V 20/54; G06V 10/426; G06V 10/764; G06V 2201/07

(57) ABSTRACT

A computer-implemented method and system relate to a multimodal classifier. A video includes a digital recording of an anomalous event. A data pair includes video frames of the anomalous event and corresponding text data describing the anomalous event. A scene graph is generated to include (i) nodes that represent selected objects of the video frames and (ii) edges that define spatial relationships between pairs of the selected objects. A scene graph encoder generates scene graph embeddings using the scene graph. A video encoder generates image embeddings using the video frames. A text encoder generates text embeddings using the text data. The multimodal classifier is trained to generate class data that classifies the anomalous event based on a concatenation of the scene graph embeddings, the image embeddings, and the text embeddings. As an example, the anomalous event is a traffic accident.

### TECHNICAL FIELD

This disclosure relates generally to computer vision and anomaly event detection, and more particularly to multimodal classification of anomalous events in digital video.

### BACKGROUND

Recognizing a traffic accident is an essential part of any autonomous driving or road monitoring system. An accident can appear in a wide variety of forms, and understanding what type of accident is taking place may be useful to prevent it from reoccurring.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method relates to training a multimodal classifier. The method includes receiving a video that includes a digital recording of a traffic accident. The video includes video frames of the traffic accident. The method includes generating a data pair. The data pair includes the video frames of the traffic accident and corresponding text data describing the traffic accident. The method includes generating a scene graph of the traffic accident. The scene graph includes nodes that represent selected objects displayed in the video frames and edges that define relationships between the selected objects. The method includes generating, via a pretrained scene graph encoder, scene graph embeddings using the scene graph. The method includes generating, via a pretrained video encoder, image embeddings using pixels of the video frames. The method includes generating, via a pretrained text encoder, text embeddings using the text data. The method includes generating, via the multimodal classifier, a predicted accident class using the image embeddings, the text embeddings, and the scene graph embeddings. The method includes computing a loss function using the predicted accident class and corresponding ground truth data. The method includes updating parameters of the multimodal classifier using the loss function.

According to at least one aspect, a system comprises one or more processors and one or more computer memory. The one or more computer memory are in data communication with the one or more processors. The one or more computer memory has computer readable data stored thereon. The computer readable data includes instructions that, when executed by one or more processors, causes the one or more processors to perform a method for training a multimodal classifier. The method includes receiving a video that includes a digital recording of an anomalous event. The video includes video frames of the anomalous event. The method includes generating a data pair. The data pair includes the video frames of the anomalous event and corresponding text data describing the anomalous event. The method includes generating a scene graph of the anomalous event. The scene graph includes nodes that represent selected objects displayed in the video frames and edges that define relationships between the selected objects. The method includes generating, via a pretrained scene graph encoder, scene graph embeddings using the scene graph. The method includes generating, via a pretrained video encoder, image embeddings using pixels of the video frames. The method includes generating, via a pretrained text encoder, text embeddings using the text data. The method includes generating, via the multimodal classifier, class data indicative of a category of the anomalous event using the image embeddings, the text embeddings, and the scene graph embeddings. The method includes computing a loss function using the class data and corresponding ground truth data. The method includes updating parameters of the multimodal classifier using the loss function.

These and other features, aspects, and advantages of the present invention are discussed in the following detailed description in accordance with the accompanying drawings throughout which like characters represent similar or like parts. Furthermore, the drawings are not necessarily to scale, as some features could be exaggerated or minimized to show details of particular components.

### BRIEF DESCRIPTION OF THE FIGURES

FIG. 1 is a diagram of an example of an overview of a process of the Scene-Traffic-Graph Inference system according to at least one example embodiment of this disclosure.

FIG. 2 is a non-limiting example of a raw digital image sampled from the digital video of FIG. 1 according to at least one example embodiment of this disclosure.

FIG. 3 is a non-limiting example of an object detection image corresponding to the raw digital image of FIG. 2 according to at least one example embodiment of this disclosure.

FIG. 4 is a non-limiting example of the scene graph of FIG. 1 according to at least one example embodiment of this disclosure.

FIG. 5 is a block diagram of an example of a system that includes the Scene-Traffic-Graph Inference system according to at least one example embodiment of this disclosure.

FIG. 6 depicts a schematic diagram of an interaction between a computer-controlled machine and a control system according to at least one example embodiment of this disclosure.

FIG. 7 depicts a schematic diagram of the control system of FIG. 6 that is configured to control a mobile machine, which is at least partially or fully autonomous, according to an example embodiment of this disclosure.

FIG. 8 depicts a schematic diagram of the control system of FIG. 6 that is configured to control a traffic monitoring system according to at least one example embodiment of this disclosure.

FIG. 9 depicts a schematic diagram of the control system of FIG. 6 that is configured to control a manufacturing machine of a manufacturing system, such as part of a production line, according to an example embodiment of this disclosure.

FIG. 10 depicts a schematic diagram of the control system of FIG. 6 that is configured to control a monitoring system according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

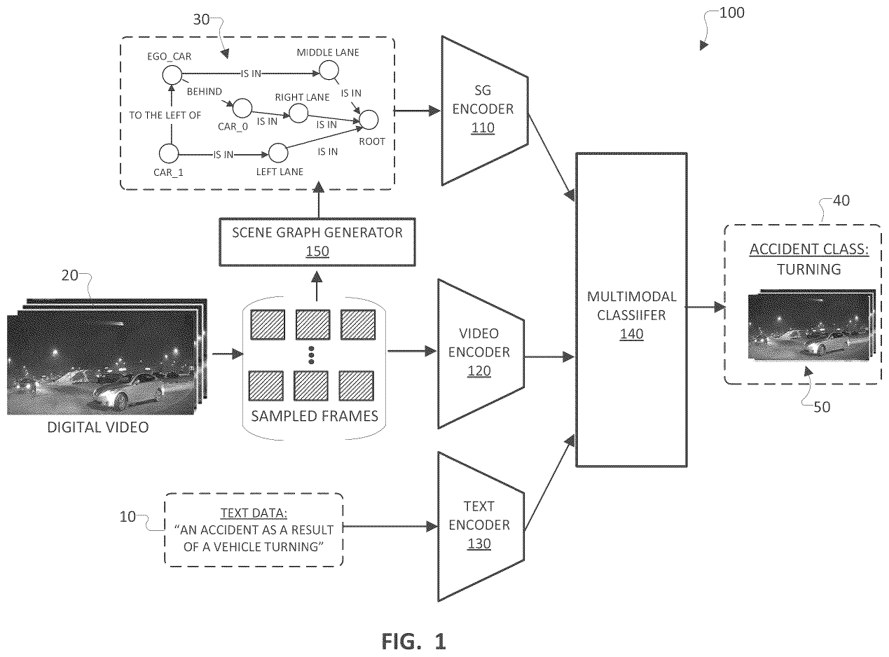

FIG. 1 is a diagram of an example of an overview of a process relating to classifying an anomalous event. In this example, the anomalous event is a traffic accident, whereby the task of understanding traffic scenarios relates to advancing Autonomous Vehicle (AV) and road infrastructure systems. An aspect of this classification task is to recognize different types of traffic accidents efficiently and accurately with the ultimate goal being to prevent them. Specifically, to approach the problem of traffic accident classification, FIG. 1 illustrates a process associated with a Scene-Traffic-Graph Inference (STGi) system 100, which is a unified system for traffic accident classification.

The process of the STGi system 100 includes a multi-stage pipeline relating to traffic accident classification. The multistage pipeline includes (1) data preprocessing, (2) scene graph encoder pretraining, (3) multimodal alignment, and (4) finetuning. The multistage pipeline is not limited to these stages but may include a different number of stages provided that the stages include similar or the same functions and achieve similar or the same results. As a general overview of the multistage pipeline, the data preprocessing includes sampling video frames, generating captions, and using a scene graph generator to produce a set of scene graphs for each traffic accident example. The scene graph encoder pretraining includes pretraining the scene graph encoder on the classification task. The multimodal alignment includes aligning the scene graph encoder with frozen video and text encoders. The finetuning process includes training a multimodal classifier 140 (e.g., one or more classification heads) on top of the alignment. Each of the stages of the multi-stage pipeline is discussed below.

The first stage includes data preprocessing. For extensibility and ease, the process is configured to leverage and tune existing tools for generating traffic scene graphs that will later be fed into the modeling approach. In this regard, various scene graph generators (SGGs) are available for this, although not many fit the specific requirements of a scene graph generator (SGG) that is capable of identifying and encoding features unique to traffic accidents, such as different types of vehicle collisions. For this application, the SGG 150 includes roadscene2vec (rs2v), which is a tool that is leveraged in this example for generating scene graphs 30 from traffic video frames. With respect to using rs2v, the process includes sampling a fixed amount or a predetermined number of frames from each video, and text captions are generated manually for each class. Then, in response to receiving a series of video frames of a traffic scene, the rs2v generator uses an object detector and keeps only the relevant entities relating to traffic (such as the road, cars, pedestrians, bicycles, etc.) while filtering out other detected objects that are non-relevant entities.

In an example, the process includes generating a bird's eye view (BEV) projection image of a video frame or a digital image. The process includes approximating the relative location of each object in the BEV projection. The process includes generating a scene graph 30 in which edges are connected between nearby entities (e.g., selected objects) in the scene. In addition, the process includes mapping nodes of selected objects (e.g., vehicles) to specific road lanes of the main road of travel that is in view. A scene graph is generated for a specific video frame from a video sample.

The SGG 150 defines the elements (e.g., nodes/entities and edges/relations) in the scene graph modality. Before employing this tool, the process includes calibrating the BEV projection image and adjusting the proximity thresholds (which are used to create edges/relations of varying attributes, such as very near or visible, relating a pair of objects). There are a number of challenges that may be faced when adjusting these settings with regard to the Detection of Traffic Anomaly (DoTA) dataset. For best results, the SGG 150 may be calibrated for each traffic scene. In this example, the process includes iteratively adjusting the BEV parameters and the proximity thresholds based on the output quality of the scene graphs produced for various scenes in DoTA. The sampling and adjustments are done to select one configuration to generate the scene graphs for the classification task, although there is an inherent challenge to generalizing the parameter settings for the entire dataset.

With respect to the text data, the process includes generating captions describing each of the various accident classes. The captions may be manually composed or automatically composed. For instance, TABLE 1 includes non-limiting examples of accident classes, which may be used to classify a video sample. In addition, the process includes generating data pairs by pairing each caption with videos from its respective class to form the training examples.

Specifically, TABLE 1 includes two sets of captions: Caption Style A and Caption Style B. As the scope of this work relates to the scene graph generation process from video frames rather than caption generation, the process uses these captions during training for aligning the scene graph (SG) encoder 110. These captions are not used during inference on the multimodal classifier 140 because they are not from the dataset and provide a one-to-one mapping directly to the accident classes. By fine-tuning the multimodal classifier 140 using these captions, the multimodal classifier 140 is enabled to achieve 100% accuracy. Instead, the multimodal classifier 140 is finetuned and tested for all examples using the following caption: “An accident as a result of a vehicle doing something.” This caption is used as text data 10, as shown in FIG. 1.

TABLE 1

| Accident Class | Caption Style A | Caption Style B |
|---|---|---|
| Moving Ahead or | The vehicle is moving | An accident as a result of |
| Waiting | ahead or waiting in | a vehicle moving into |
| | the accident. | another vehicle. |
| Oncoming | The vehicle is hitting an | An accident as a result of a |
| | oncoming vehicle in the | vehicle hitting an oncoming |
| | accident. | vehicle. |
| Turning | The vehicle is turning | An accident as a result |
| | in the accident. | of a vehicle turning. |
| Lateral | The vehicle is moving | An accident as a result |
| | laterally in the accident | of a vehicle moving |
| | | laterally. |

The second stage includes pretraining the SG encoder 110 to encode the scene graphs to fixed-length scene graph embeddings. To do this, a multi-relational graph convolutional network (MRGCN) is employed. The MRGCN includes an attention mechanism along with LSTMs to model the spatial and temporal relations of the scene graphs generated for a given video. The SG encoder 110 may be pretrained for the classification task before aligning the scene graphs with the language and vision modalities.

The third stage includes multimodal alignment. In FIG. 1, the multimodal alignment involves aligning the SG encoder 110 with a contrastively-trained foundation model (e.g., video encoder 120 and text encoder 130). As an example, the video encoder 120 comprises a minimal extension of contrastive language-image pretraining (X-CLIP) encoder. The X-CLIP encoder is a pre-trained video encoder that receives and processes videos. X-CLIP directly expands upon CLIP's image encoder to include an attention mechanism to model inter-frame communication and to generate a new embedding representation from video frames. Also, in FIG. 1, the text encoder 130 is taken from a pretrained vision language model, such as the contrastive language-image pretraining (CLIP) model. As an example, the text encoder 130 comprises the CLIP text encoder. The multimodal alignment includes freezing the weights from the video encoder 120 and the text encoder 130 to align the video encoder 120 and the text encoder 130 to the SG encoder 110.

The fourth stage includes finetuning the multimodal classifier 140 for a downstream task. Specifically, the fourth stage involves training the multimodal classifier 140 that receives and accepts embeddings from the three modalities provided by the SG encoder 110, the video encoder 120, and the text encoder 130 and outputs an accident class 40 (TABLE 1) for a traffic scene. Also, as shown in FIG. 1, the accident class 40 may be provided with the corresponding digital video frames 50 associated with the accident class 40. In essence, the scene graphs are treated as a new modality (or ‘view’) that is aligned with the text and video modalities, whereby all three modalities are fused together to classify traffic accident scenes. In this regard, the fourth stage includes fusing the signals from the three modalities followed by training the multimodal classifier 140. The three modalities are fused before the downstream task at hand, such as early and late stage fusion involving concatenation, merging, or sampling from a shared embedding space. The fusion may include fusion techniques such as taking a weighted linear combination of the modality outputs and training various multilayer perceptron (MLP) classifiers with and without activations on top of the concatenated embeddings. Specifically, in FIG. 1, the fusion includes concatenating the vectors from the three distinct modalities and training a 2-layer MLP with rectified linear unit (ReLU) activations of the multimodal classifier 140.

As discussed above, the STGi system 100 is configured to classify an anomalous traffic scene as a specific type of traffic accident. TABLE 1 shows examples of traffic accident classifications. Moreover, FIG. 1 introduces a multi-stage, multimodal pipeline to pre-process videos of traffic accidents, encode them as scene graphs, and align this representation with vision and language modalities for accident classification. In this regard, the problem of classifying a traffic scene is approached by modeling a traffic scene via at least one scene graph, where particular objects (e.g., cars, pedestrians, roads, etc.) are represented as nodes, and relative distances and directions between them as edges that connect particular pairs of nodes. That is, in addition to a data pair that includes digital video 20 and corresponding text data 10 that describes the digital video 20, the scene graph 30 of a traffic scene is also provided as input embedding data to the multimodal classifier 140. This fusion of the three modalities enables the multimodal classifier 140 to achieve better and more accurate classification results.

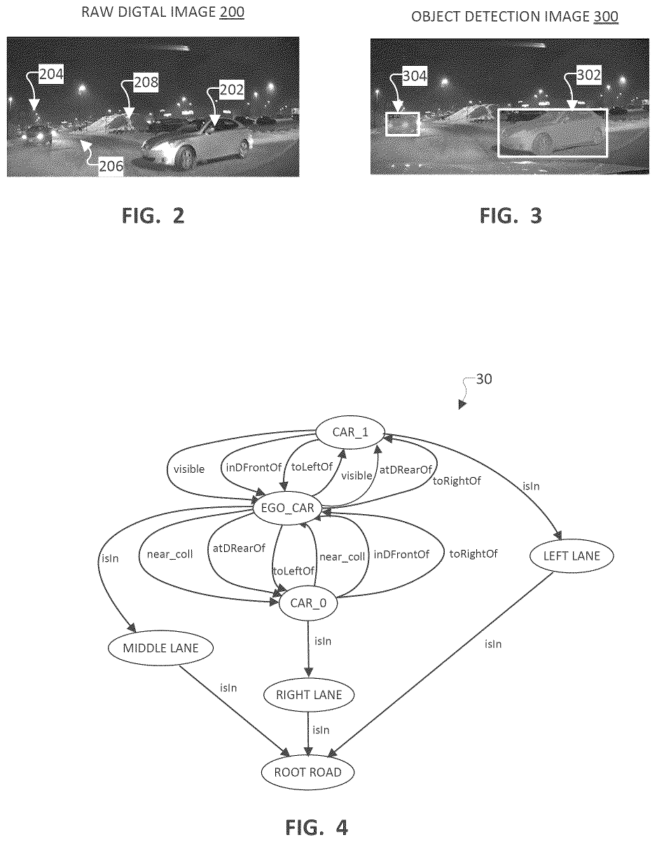

FIG. 2, FIG. 3, and FIG. 4 are non-limiting data examples that are shown in FIG. 1. Specifically, FIG. 2 is an example of a raw digital image 200, which is taken from a video frame of the digital video. In this non-limiting example, the raw digital image 200 is taken from a viewpoint of an ego vehicle. The raw digital image 200 displays a vehicle 202 and a vehicle 204 in a view of the ego vehicle. The raw digital image 200 also shows a main road 206 on which the ego vehicle is driving. Also, in a distant view, the raw digital image 200 shows other distant objects 208 (e.g. other cars, a light post, etc.) at a distance from the ego vehicle. Meanwhile, FIG. 3 illustrates an object detection image 300 that corresponds to the raw digital image 200. The object detection image 300 shows a selection of detected objects of the raw digital image 200. In particular, the object detection image 300 shows at least (i) an image segment 302 and bounding box for the vehicle 202 and (ii) an image segment 304 and bounding box for the vehicle 204. However, the object detection image 300 does not include an image segment for the other distant objects 208.

In addition, FIG. 4 illustrates an example of a scene graph 30, which is generated based on the example data provided in FIG. 1, FIG. 2, and FIG. 3. The scene graph provides a logical and spatial representation of a scene of at least one digital image or digital video frame. Specifically, in this example, the scene graph 30 is generated via SGG 150. There are a number of SGGs that are available. As a non-limiting example, in this case, the SGG 150 comprises roadscene2vec (“rs2v”), as the current example relates to road scenes. Starting from a video frame, such as raw digital image 200 (FIG. 2), the SGG 150 detects objects in the scene. In this regard, FIG. 3 provides an example of an object detection image 300 in which segmentation masks are generated to identify selected objects in the scene. Also, according to one embodiment, the process includes generating a bird's eye view (BEV) image before generating the scene graph 30 to obtain a better viewpoint for spatial relationships among the selected detected objects. The selection of objects for the scene graph is chosen based on relevance to the traffic scene.

As shown in FIG. 4, the SGG 150 generates the scene graph 30 that includes nodes and edges. In this example, the scene graph 30 is based on the viewpoint of the ego vehicle, and thus includes a node for the ego vehicle along with a number of relations of the ego vehicle with respect to other selected objects. Specifically, in the examples shown in FIG. 4, the scene graph 30 includes a node for the ego vehicle (“EGO_CAR” node), a node for the vehicle 202 (“CAR_0” node), a node for the vehicle 204 (“CAR_1” node), a node for the road (“ROOT ROAD” node) on which the ego vehicle is driving, a node for the right lane (“RIGHT LANE” node) of the road, a node for the left lane (“LEFT LANE” node) of the road, and a node for the middle lane (“MIDDLE LANE” node) of the road. In this regard, the SGG 150 generates nodes for a selection of detected objects (e.g., relevant objects such as vehicles, etc.) and a detected road and its specific lanes relating to locations of the ego vehicle and the other selected objects.

In addition, in FIG. 4, the scene graph 30 includes a relation, which corresponds to an edge (an “arrow”) between a first node (“subject entity”) and a second node (“an object entity”). For example, an edge may include spatial and/or proximity relation (e.g. visible, near, very near, etc.). Also, the edge may indicate that there is a direct field of view (e.g., “is at Direct rear of”), between two selected objects (e.g. ego vehicle and vehicle 204) in the digital video frame when there are no other objects between these two selected objects. Specifically, in FIG. 4, the SGG 150 generates a scene graph 30 with categorical distance relations between the ego vehicle and certain objects in its surroundings, along with mappings to a fixed set of three traffic lanes (left, middle, and right). TABLE 2 provides a different representation of the information, which is shown in the scene graph 30 of FIG. 4.

TABLE 2
SCENE GRAPH (FIG. 4)

| SUBJECT ENTITY | RELATION | OBJECT ENTITY |
|---|---|---|
| EGO_VEHICLE | is in | MIDDLE LANE |
| EGO_VEHICLE | is near collision with | CAR_0 |
| EGO_VEHICLE | is at Direct rear of | CAR_0 |
| EGO_VEHICLE | is to the left of | CAR_0 |
| EGO_VEHICLE | is to the left of | CAR_1 |
| EGO_VEHICLE | is visible to | CAR_1 |
| EGO_VEHICLE | is at Direct rear of | CAR_1 |
| CAR_0 | is in | RIGHT LANE |
| CAR_0 | is in Direct front of | EGO_CAR |
| CAR_0 | is to the right of | EGO_CAR |
| CAR_0 | is near collision with | EGO_CAR |
| CAR_1 | is in | LEFT LANE |
| CAR_1 | is visible to | EGO_CAR |
| CAR_1 | is in Direct front of | CAR_1 |
| CAR_1 | is to the left of | EGO_CAR |
| LEFT LANE | is in | ROOT ROAD |
| MIDDLE LANE | is in | ROOT ROAD |
| RIGHT LANE | is in | ROOT ROAD |

As discussed above, the scene graph 30 shows the ego vehicle relative to two other vehicles, where one vehicle 202 is categorized as being in the left lane and the other vehicle 204 is characterized as being in the right lane with respect to a viewpoint of the ego vehicle. The closer vehicle 202 (“CAR_O”) is recognized as being near collision (with the edge attribute “near coll”), whereas the farther vehicle 204 (“CAR_1”) is registered in the scene graph as simply being “visible.” The scene graph contributes to and improves traffic accident classification.

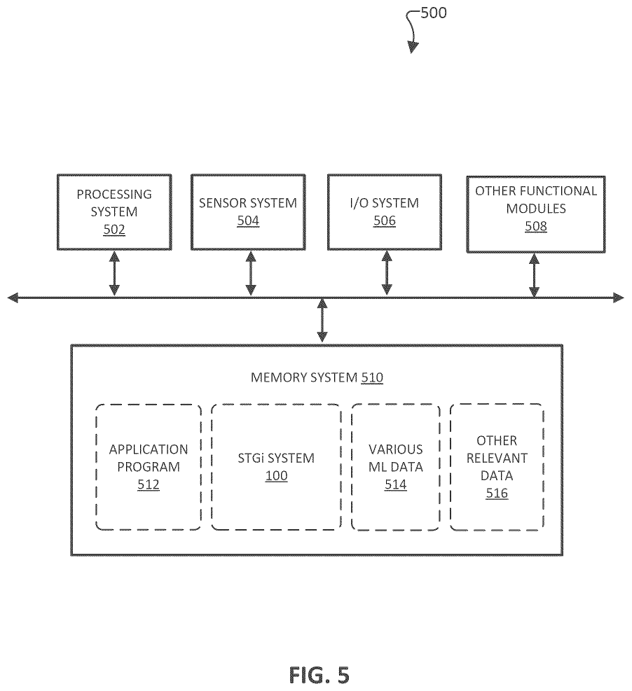

FIG. 5 is a diagram of an example of a system 500 with the STGi system 100 according to an example embodiment. The system 500 includes at least a processing system 502. The processing system 502 includes one or more processing devices. For example, the processing system 502 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 502 is operable to provide the functionality as described herein.

The system 500 includes at least a memory system 510, which is operatively connected to the processing system 502. The memory system 510 is in data communication with the processing system 502. In an example embodiment, the memory system 510 includes at least one non-transitory computer readable medium, which is configured to store and provide access to various data to enable at least the processing system 502 to perform the operations and functionality, as disclosed herein. In an example embodiment, the memory system 510 comprises a single device or a plurality of devices. The memory system 510 can include electrical, electronic, magnetic, optical, semiconductor, electromagnetic, or any suitable storage technology that is operable with the system 500. For instance, in an example embodiment, the memory system 510 can include random access memory (RAM), read only memory (ROM), flash memory, a disk drive, a memory card, an optical storage device, a magnetic storage device, a memory module, any suitable type of memory device, or any combination thereof.

The memory system 510 includes at least the STGi system 100, an application program 512, various machine learning (ML) data 514, and other relevant data 516, which are stored thereon. The memory system 510 includes computer readable data that, when executed by the processing system 502, is configured provide the functions and processes as described in the present disclosure. The computer readable data can include instructions, code, routines, various related data, any software technology, or any number and combination thereof. Specifically, the application program 512 includes computer readable data with instructions, which when executed by the processing system 502, is configured to provide an application platform for the STGi system 100 to operate with other components of the system 500 and interface with a user. Also, the STGi system 100 includes computer readable data with instructions, which when executed by the processing system 502, is configured to perform the process described in at least FIG. 1. For example, the STGi system 100 is configured to train the multimodal classifier 140. As another example, the STGi system 100 is configured to generate at least event classification data (e.g., traffic accident class) upon receiving input data, as described in this disclosure. Also, the various ML data 514 includes various training data, various loss data, various weight data and/or parameter data, as well as any related machine learning data that enables the system 500 to perform the functions as disclosed in this disclosure. For example, the various training data includes at least various digital video, various digital images and/or digital frames, various loss data, various text data, various scene graph data, and other related ML data. Meanwhile, the other relevant data 516 provides various data (e.g. operating system, etc.), which enables the system 500 to perform the functions as discussed herein.

In an example embodiment, as shown in FIG. 5, the system 500 is configured to include at least one sensor system 504. The sensor system 504 includes one or more sensors. For example, the sensor system 504 includes an image sensor or a camera, which is configured to capture digital images and/or digital video. The sensor system 504 may also include a radar sensor, a light detection and ranging (LIDAR) sensor, a thermal sensor, an ultrasonic sensor, an infrared sensor, a motion sensor, an audio sensor, an inertial measurement unit (IMU), any suitable sensor, or any combination thereof. The sensor system 504 is operable to communicate with one or more other components (e.g., processing system 502 and memory system 510) of the system 500. More specifically, for example, the processing system 502 is configured to obtain the sensor data directly or indirectly from at least one sensor. The sensor system 504 and/or the processing system 502 is configured to generate digital images and/or digital video. The processing system 502 is configured to process digital images and/or digital video in connection with the STGi system 100 and the various ML data 514.

In addition, the system 500 includes other components that contribute to the STGi system 100. For example, as shown in FIG. 5, the memory system 510 is also configured to store other relevant data 516, which relates to operation of one or more components (e.g., sensor system 504, an input/output (I/O) system 506, and other functional modules 508). In addition, the I/O system 506 includes an I/O interface and may include one or more devices (e.g., display device, keyboard device, speaker device, etc.). Also, the system 500 includes other functional modules 508, such as any appropriate hardware technology, software technology, or combination thereof that assist with or contribute to the functioning of the system 500. For example, the other functional modules 508 include communication technology that enables components of the system 500 to communicate at least with each other, as described herein. The communication technology may enable the system 500 to communicate with other network devices (not shown) over a communication network. With at least the configuration discussed in the example of FIG. 5, the system 500 is configured to enable the STGi system 100 to perform the functions as discussed in this disclosure.

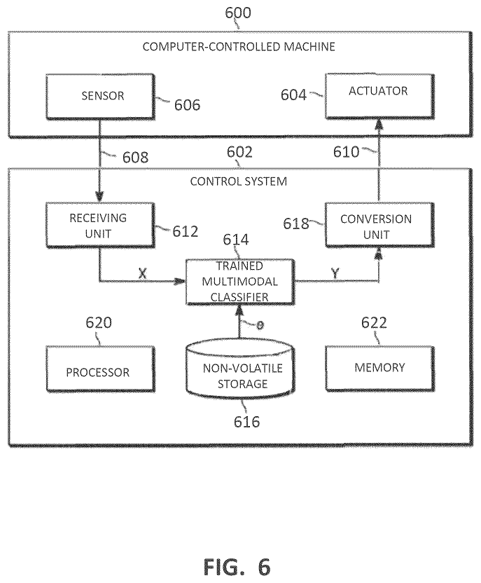

FIG. 6 illustrates a schematic diagram of an interaction between computer-controlled machine 600 and control system 602 according to another example embodiment. Computer-controlled machine 600 includes actuator 604 and sensor 606. Actuator 604 may include one or more actuators and sensor 606 may include one or more sensors. Sensor 606 is configured to sense a condition of computer-controlled machine 600. Sensor 606 may be configured to encode the sensed condition into sensor signals 608 and to transmit sensor signals 608 to control system 602. A non-limiting example of sensor 606 includes video, radar, LiDAR, an ultrasonic sensor, an image sensor, an audio sensor, a motion sensor, etc. In some embodiments, sensor 606 is an image sensor or an optical sensor configured to provide digital images of an environment proximate to computer-controlled machine 600.

Control system 602 is configured to receive sensor signals 608 from computer-controlled machine 600. As set forth below, control system 602 may be further configured to compute actuator control commands 610 depending on the sensor signals and to transmit actuator control commands 610 to actuator 604 of computer-controlled machine 600.

As shown in FIG. 6, control system 602 includes receiving unit 612. Receiving unit 612 may be configured to receive sensor signals 608 from sensor 606 and to transform sensor signals 608 into input signals x. In an alternative embodiment, sensor signals 608 are received directly as input signals x without receiving unit 612. Each input signal x may be a portion of each sensor signal 608. Receiving unit 612 may be configured to process each sensor signal 608 to product each input signal x. Input signal x may include data corresponding to a digital image/video recorded by sensor 606.

Control system 602 includes classifier 614. In this example, the classifier 614 is the multimodal classifier 140 that is trained and/or finetuned via the process of FIG. 1. However, in each of applied case, the multimodal classifier 140 is trained with training data (e.g., digital video data, text data, and scene graph data) that relates directly to the application (e.g., autonomous vehicle/robots, traffic monitoring systems, manufacturing systems, security systems, etc.) in which the multimodal classifier 140 is applied. In addition, the appropriate SGG is selected and used for training the multimodal classifier 140 for each of these applications. Also, the digital video data is taken from a viewpoint that corresponds to a position of the camera in the application and/or is suitable for that application (e.g., autonomous vehicles, traffic systems, manufacturing systems, security systems, etc.). In this regard, the multimodal classifier 140 is trained to classify anomalous events in digital video that relates to its application. The classifier 614 may be configured to classify input signals x into one or more labels using ML algorithms. Classifier 614 is configured to be parametrized by parameters θ. Parameters θ may be stored in and provided by non-volatile storage 616. Classifier 614 is configured to determine output signals y from input signals x. Each output signal y includes information that assigns one or more labels to each input signal x. Classifier 614 may transmit output signals y to conversion unit 618. Conversion unit 618 is configured to covert output signals y into actuator control commands 610. Control system 602 is configured to transmit actuator control commands 610 to actuator 604, which is configured to actuate computer-controlled machine 600 in response to actuator control commands 610. In some embodiments, actuator 604 is configured to actuate computer-controlled machine 600 based directly on output signals y.

Upon receipt of actuator control commands 610 by actuator 604, actuator 604 is configured to execute an action corresponding to the related actuator control command 610. Actuator 604 may include a control logic configured to transform actuator control commands 610 into a second actuator control command, which is utilized to control actuator 604. In one or more embodiments, actuator control commands 610 may be utilized to control a display instead of or in addition to an actuator.

In some embodiments, control system 602 includes sensor 606 instead of or in addition to computer-controlled machine 600 including sensor 606. Control system 602 may also include actuator 604 instead of or in addition to computer-controlled machine 600 including actuator 604. As shown in FIG. 6, control system 602 also includes processor 620 and memory 622. Processor 620 may include one or more processors. Memory 622 may include one or more memory devices. The classifier 614 of one or more embodiments may be implemented by control system 602, which includes non-volatile storage 616, processor 620, and memory 622.

Non-volatile storage 616 may include one or more persistent data storage devices such as a hard drive, optical drive, tape drive, non-volatile solid-state device, cloud storage or any other device capable of persistently storing information. Processor 620 may include one or more devices selected from high-performance computing (HPC) systems including high-performance cores, graphics processing units, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 622. Memory 622 may include a single memory device or a number of memory devices including, but not limited to, RAM, ROM, volatile memory, non-volatile memory, static random access memory (SRAM), dynamic random access memory (DRAM), flash memory, cache memory, or any other device capable of storing information.

Processor 620 is configured to read into memory 622 and execute computer-executable instructions residing in non-volatile storage 616 and embodying one or more ML algorithms and/or methodologies of one or more embodiments. Non-volatile storage 616 may include one or more operating systems and applications. Non-volatile storage 616 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 620, the computer-executable instructions of non-volatile storage 616 may cause control system 602 to implement one or more of the ML algorithms and/or methodologies to employ the classifier 614 as disclosed herein. Non-volatile storage 616 may also include ML data (including model parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes, layers, or blocks than those illustrated consistent with one or more embodiments. Furthermore, the processes, methods, or algorithms can be embodied in whole or in part using suitable hardware components, such as ASICs, FPGAs, state machines, controllers or other hardware components or devices, or a combination of hardware, software and firmware components.

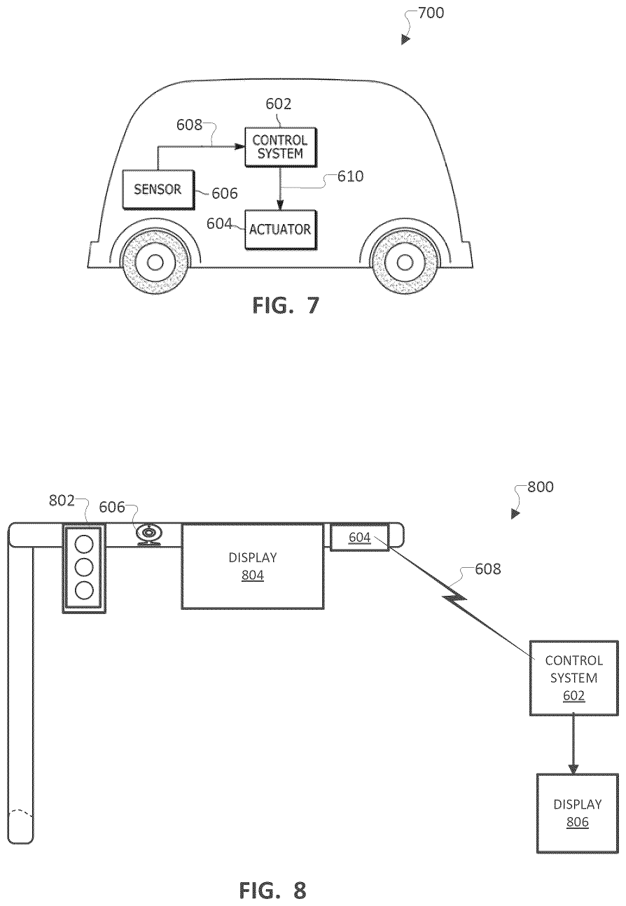

FIG. 7 depicts a schematic diagram of control system 602 configured to control vehicle 700, which may be at least a partially autonomous vehicle or at least a partially autonomous robot. Vehicle 700 includes actuator 604 and sensor 606. Sensor 606 includes one or more image sensors (e.g. video cameras). In addition, sensor 606 may include radar sensors, ultrasonic sensors, LiDAR sensors, and/or position sensors (e.g. Global Positioning System). One or more of the one or more specific sensors may be integrated into vehicle 700. Alternatively or in addition to one or more specific sensors identified above, sensor 606 may include a software module configured to, upon execution, determine a state of actuator 604. One non-limiting example of a software module includes a weather information software module configured to determine a present or future state of the weather proximate to the vehicle 700 or at another location.

In this example, in response to input signals x, the classifier 614 is configured to output signal y, which includes include classifying traffic scenes in a vicinity of the vehicle 700. Actuator control command 610 may be determined in accordance with this information. The actuator control command 610 may be used to control the vehicle 700 to avoid further collisions based on the traffic accident classification and/or transmit alert notifications regarding the traffic accident classification to the appropriate entities (e.g., emergency responders, police, ambulance, etc.).

In some embodiments, the vehicle 700 is an at least partially autonomous vehicle or a fully autonomous vehicle. The actuator 604 may be embodied in a brake, a propulsion system, an engine, a drivetrain, a steering of vehicle 700, etc. Actuator control commands 610 may be determined such that actuator 604 is controlled such that vehicle 700 avoids further collisions with detected objects and/or is controlled such that vehicle 700 is stopped and/or maneuvered to a safe location after classifying the traffic accident. The actuator control commands 610 may be determined depending on the classification of the anomalous event (e.g., traffic accident).

In some embodiments in which the vehicle 700 is at least a partially autonomous mobile robot, the mobile robot is configured to carry out one or more functions, such as flying, swimming, diving, and stepping. As non-limiting examples, the mobile robot may at least partially autonomous and may be a lawn mower, a cleaning robot, a drone, etc. In such embodiments, the actuator control command 610 may be determined such that a propulsion unit, steering unit, brake unit, or another actuator unit of the mobile robot may be controlled such that the mobile robot may avoid a collision based on a classification of the anomalous event, as well as current information pertaining to the selected objects.

FIG. 8 depicts a schematic diagram of the control system 602 of FIG. 6 that is configured to control a traffic monitoring system 800 according to at least one example embodiment of this disclosure. In this case, the traffic monitoring system 800 may include the control system 602 to control a traffic light 802, a display device 804, a display device 806, or any number and combination thereof. Sensor 606 is configured to capture digital video of a traffic scene. Sensor 606 includes an image sensor (e.g., camera) configured to generate and transmit digital images and/or digital video data. Such data may be used by control system 602 to detect a suspicious or anomalous event that occurs near the traffic light 802.

Classifier 614 of control system 602 of the traffic monitoring system 800 may be configured to interpret the digital images and/or digital video by classifying anomalous events that occur around the sensor 606. Classifier 614 may be configured to generate an actuator control command 610 in response to the interpretation and classification of a traffic scene of the image and/or video data. Control system 602 is configured to transmit the actuator control command 610 to actuator 604. In an example, the actuator 604 is configured to change a traffic light signal of the traffic light 802 in response to the actuator control command 610. Additionally or alternatively, the actuator 604 may be configured to change a display device 804 (e.g., electronic message sign) to provide a message to notify other drivers of the anomalous event. Additionally or alternatively, the control system 602 is configured to transmit an actuator control command 610 to a remote and/or mobile display device 806 to display the digital video and its classification to notify a relevant entity (e.g., police, ambulances, etc.) of the anomalous event.

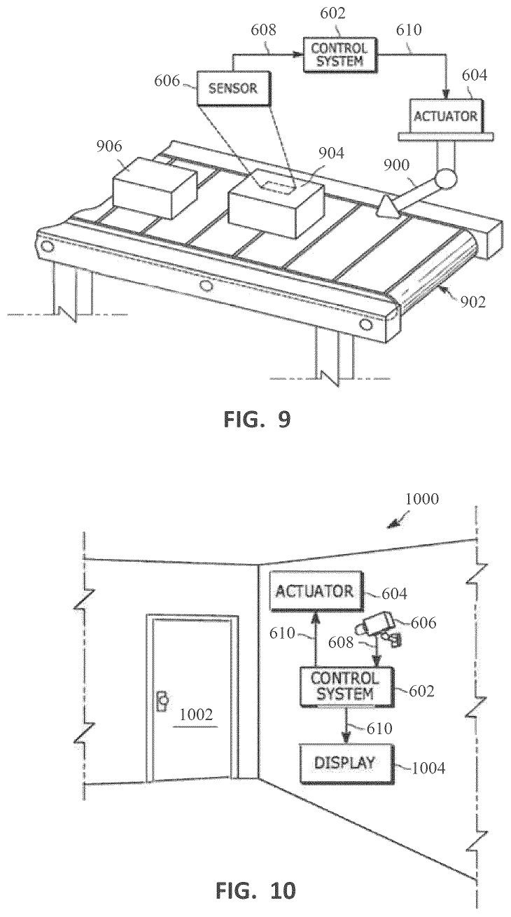

FIG. 9 illustrates a schematic diagram of control system 602 configured to control a system 900 (e.g., manufacturing machine or a manufacturing assembly). In addition, the control system 602 is configured to control an actuator 604, which is configured to control one or more actions associated with the system 900. Also, sensor 606 includes one or more image sensors (e.g., video cameras) that capture digital images of objects (e.g., products or one or more portions thereof) that are at (i) a particular manufacturing stage, and/or (ii) a particular time in which these are objects are inspected for quality control purposes. Also, in this application, the classifier 614 is configured to classify an anomalous event of a digital video sample.

Actuator 604 is configured to control the system 900 (e.g., manufacturing machine) depending on the determined state (e.g., anomalous classification) of a product 904 or one or more portions thereof. The actuator 604 may control functions of system 900 (e.g., manufacturing machine) with respect to subsequent manufactured products 906 of system 900 (e.g., manufacturing machine) depending on the classification of the anomalous event. For example, when the control system 602 determines, via the classifier 614, that there is a particular class or type of anomalous event associated with product 904, then the control system 602 is configured to instruct actuator 604 to control the system 900 such that the product 904 is removed from the production line 902 for further inspection. In another example, the control system 602 is configured to halt a movement of the production line 902 while awaiting further inspection of manufactured product 904. In such examples, the inspection of manufactured product 906 may be paused until the state of manufactured product 904 is determined. Additionally or alternatively, the control system 602 is configured to transmit the video frames of the digital sample and the anomalous event classification data to another communication device (e.g., another computer system, a display device, a mobile communication system, etc.) as an alert notification.

FIG. 10 depicts a schematic diagram of control system 602 configured to control security monitoring system 1000. Security monitoring system 1000 may be configured to physically control access through door 1002. Sensor 606 may be configured to detect a scene that is relevant in deciding whether access is granted. Sensor 606 may be an optical sensor (e.g., camera) configured to generate and transmit image and/or video data. Such data may be used by control system 602 to detect a suspicious or anomalous event that occurs near the door 1002.

Classifier 614 of control system 602 of security monitoring system 1000 may be configured to interpret the digital images and/or digital video by classifying events that occur around the sensor 606. Classifier 614 may be configured to generate an actuator control command 610 in response to the interpretation of the image and/or video data. Control system 602 is configured to transmit the actuator control command 610 to actuator 604. In this embodiment, the actuator 604 is configured to lock or unlock door 1002 in response to the actuator control command 610. In some embodiments, a non-physical, logical access control is also possible.

Security monitoring system 1000 may also be a surveillance system. In such an embodiment, sensor 606 may be an optical sensor configured to detect a scene that is under surveillance and the control system 602 is configured to control display 1004. Classifier 614 is configured to determine a classification of a scene, e.g. whether the scene detected by sensor 606 includes a suspicious event or an anomalous event (e.g., removing a mailing package from the door, a wild animal near the door/home/building, etc.). Control system 602 is configured to transmit an actuator control command 610 to display 1004 the video in response to the classification. Display 1004 may be configured to adjust the displayed content in response to the actuator control command 610. For instance, display 1004 is configured to display the digital video sample that is deemed to be a particular type of anomalous event by classifier 614.

As described in this disclosure, the embodiments provide a number of advantageous features and benefits. For example, the STGi system 100 is configured to classify a traffic scene as a specific type of accident. The STGi system 100 models a traffic scene via a scene graph, where predetermined objects, such as vehicles are represented as nodes, and spatial relationships (e.g., relative distances and relative directions) between these predetermined objects are represented as edges. The STGi system 100 achieves better results using a fusion of the scene graph modality, the vision modality, and the language modality. In addition, the STGi system 100 includes a multi-stage, multimodal pipeline to pre-process videos of traffic accidents, encode them as scene graphs, and align the scene graph modality with the vision modality and the language modality for traffic accident classification. As an example, when trained on 4 classes (TABLE 1), the STGi system 100 achieves a balanced accuracy score of 57.77% on an (unbalanced) subset of the popular DoTA benchmark, representing an increase of close to 5 percentage points from the case where scene graph information is not taken into account. The STGi system 100 improves classification performance.

The STGi system 100 presents a novel method for traffic accident classification, which leverages scene graphs to capture the essential features of a traffic accident. The STGi system 100 is advantageous in that the added signal from a scene graph modality enhances the performance of a video-language traffic accident classifier by nearly 5 percentage points. In addition, experiments in this work demonstrate that aligning the scene graph modality with vision and language together while also increasing the batch size and training time during alignment shows a trend of increasing scores and further improving traffic accident classification results.

Also, the STGi system 100 is innovative in incorporating scene graphs as an additional modality, which is grounded to the video encoder 120 and the text encoder 130. The STGi system 100 is configured to encode traffic information in the form of a scene graph, which is beneficial in classifying traffic accidents. This is made clear by the pretraining encoder results which show the ability of the SG encoder 110 to beat a random classifier at this task. It was further illustrated that the scene graph information can serve to enhance the performance of a vision-language classifier by fusing information from all three modalities.

Furthermore, there may be variations to the STGi system 100. For example, the captions for each digital video may be derived from the digital video itself similarly to the scene graphs. This modification to the caption generation enables the captions to be fed into the STGi system 100 to fine-tune the multimodal classifier 140 and run inference with a greater signal coming from the language modality. Additionally or alternatively, the scene graphs may be expanded to include a semantic extension such that semantic relationships are provided between nodes to enhance the signal obtained from the scene graph modality. Also, the scene graphs may be modified to include relations between all objects in the scene (and not just a set of predetermined/selected objects), this pipeline can be expanded for the non-ego case as well, and perhaps can be used on more classes in the DoTA dataset or similar use cases. Additionally, the MRGCN-based architecture of the SG encoder 110 may be further improved by modifying either its spatial or temporal modeling components. Also, the STGi system 100 may be modified to include different modality fusion methods and/or different classifier architectures for the multimodal classifier 140.

Furthermore, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally, or alternatively, components and functionality may be separated or combined differently than in the manner of the various described embodiments and may be described using different terminology. These and other variations, modifications, additions, and improvements may fall within the scope of the disclosure as defined in the claims that follow.

1. A computer-implemented method for training a multimodal classifier, the method comprising:
receiving a video that includes a digital recording of a traffic accident;
generating a data pair, the data pair including video frames of the traffic accident and corresponding text data describing the traffic accident;
generating a scene graph for the traffic accident, the scene graph including nodes that represent selected objects displayed in the video frames and edges that define relationships between the selected objects;
generating, via a pretrained scene graph encoder, scene graph embeddings using the scene graph;
generating, via a pretrained video encoder, image embeddings using the video frames;
generating, via a pretrained text encoder, text embeddings using the text data; and
generating, via the multimodal classifier, a predicted accident class using the image embeddings, the text embeddings, and the scene graph embeddings;
computing a loss function using the predicted accident class and corresponding ground truth data; and
updating parameters of the multimodal classifier using the loss function.

2. The computer-implemented method of claim 1, wherein the multimodal classifier comprises a multi-headed architecture that includes a 2-layer a multilayer perceptron (MLP) with rectified linear unit (ReLU) activations.

3. The computer-implemented method of claim 1, wherein the loss function includes a Symmetric Cross Entropy Loss.

4. The computer-implemented method of claim 1, further comprising:
generating concatenated data by concatenating the scene graph embeddings, the image embeddings, and the text embeddings,
wherein the multimodal classifier receives the concatenated data as input and generates the predicted accident class as output.

5. The computer-implemented method of claim 1, further comprising:
detecting objects in at least one particular video frame; and
extracting the selected objects from among the detected objects,
wherein,
the scene graph is generated using the selected objects, and
a pair of the selected objects are connected to each other in the scene graph by a spatial relation.

6. The computer-implemented method of claim 5, wherein:
the detected objects include the selected objects and unselected objects; and
the unselected objects do not form a part of the scene graph.

7. The computer-implemented method of claim 1, wherein the selected objects include at least a vehicle and a road of the vehicle.

8. The computer-implemented method of claim 1, wherein the scene graph encoder comprises a multirelational graph convolutional network (MRGCN) that includes an attention mechanism along with long short-term memories (LSTMs) to model spatial and temporal relations of the scene graph.

9. The computer-implemented method of claim 1, further comprising:
generating a top plan view of at least one particular video frame; and
generating relationship data among the selected objects using the top plan view,
wherein the relationship data include mappings of one or more vehicles to specific road lanes.

10. The computer-implemented method of claim 1, wherein:
the pretrained video encoder and the pretrained text encoder are a part of a pretrained vision language model; and
the vision language model includes parameters that are frozen during the training of the multimodal classifier.

11. A system comprising:
one or more processors;
one or more computer memory in data communication with the one or more processors, the one or more computer memory having computer readable data stored thereon, the computer readable data including instructions that, when executed by one or more processors, causes the one or more processors to perform a method for training a multimodal classifier, the method including
receiving a video that includes a digital recording of an anomalous event;
generating a data pair, the data pair including video frames of the anomalous event and corresponding text data describing the anomalous event;
generating a scene graph of the anomalous event, the scene graph including nodes that represent selected objects displayed in the video frames and edges that define relationships between the selected objects;
generating, via a pretrained scene graph encoder, scene graph embeddings using the scene graph;
generating, via a pretrained video encoder, image embeddings using the video frames;
generating, via a pretrained text encoder, text embeddings using the text data; and
generating, via the multimodal classifier, class data indicative of a category of the anomalous event using the image embeddings, the text embeddings, and the scene graph embeddings;
computing a loss function using the class data and corresponding ground truth data; and
updating parameters of the multimodal classifier using the loss function.

12. The system of claim 11, wherein the multimodal classifier comprises a multi-headed architecture that includes a 2-layer a multilayer perceptron (MLP) with rectified linear unit (ReLU) activations.

13. The system of claim 11, wherein the loss function includes a Symmetric Cross Entropy Loss.

14. The system of claim 11, further comprising:
generating concatenated data by concatenating the scene graph embeddings, the image embeddings, and the text embeddings,
wherein the multimodal classifier receives the concatenated data as input and generates the predicted accident class as output.

15. The system of claim 11, further comprising:
detecting objects in at least one particular video frame; and
extracting the selected objects from among the detected objects,
wherein,
the scene graph is generated using the selected objects, and
a pair of selected objects are connected to each other in the scene graph by a spatial relation.

16. The system of claim 11, wherein the anomalous event is a traffic accident.

17. The system of claim 11, wherein the selected objects include at least a vehicle and a road of the vehicle.

18. The system of claim 1, wherein the scene graph encoder comprises a multirelational graph convolutional network (MRGCN) that includes an attention mechanism along with long short-term memories (LSTMs) to model spatial and temporal relations of the scene graph.

19. The system of claim 11, further comprising:
generating a top plan view of at least one particular video frame; and
generating relationship data among the selected objects using the top plan view,
wherein the relationship data include mappings of one or more vehicles to specific road lanes.

20. The system of claim 11, wherein:
the pretrained video encoder and the pretrained text encoder are a part of a pretrained vision language model; and
the vision language model includes parameters that are frozen during the training of the multimodal classifier.
